(19) United States
(12) Patent Application Publication
(10) Pub. No.: US 2010/0027481 A1
(43) Pub. Date: Feb. 4, 2010

(54) Common resource signaling for multiple types of allocations

(75) Inventors: Lars E. Lindh, Helsingfors (FI); Jussi K. Ojala, Helsinki (FI); Frank Frederiksen, Klarup (DK)

Correspondence Address: HARRINGTON & SMITH, PC, 4 RESEARCH DRIVE, Suite 202, SHELTON, CT, 06484-6212, US

(73) Assignee: Nokia Corporation

(21) Appl. No.: 12/228,505

(22) Filed: Aug. 12, 2008

Related U.S. Application Data
(60) Provisional application No. 60/964,660, filed on Aug. 13, 2007.

(51) Int. Cl. H04W 72/04

(52) U.S. Cl. 370/329

(57) ABSTRACT

The exemplary embodiments of this invention provide a multi-stage approach, where, for example, one number can signal a first type of resource allocation (e.g., a consecutive allocation) or a second type of resource allocation (e.g., a best-M allocation based on best-M channel quality information). In one exemplary embodiment, a method includes: allocating a plurality of resource blocks to obtain a resource allocation; and signaling the resource allocation using an n-bit number, where the n-bit number expresses a value from an overall range of values having a first range of values and a second range of values, where a value within the first range of values specifies a first type of resource allocation and where a value within the second range of values specifies a second type of resource allocation, where the first type of resource allocation is different from the second type of resource allocation.

### CROSS-REFERENCE TO RELATED APPLICATIONS

This patent application claims priority under 35 U.S.C. §119(e) from U.S. Provisional Patent Application No. 60/964,660, filed Aug. 13, 2007, the disclosure of which is incorporated by reference herein in its entirety.

### TECHNICAL FIELD

The exemplary and non-limiting embodiments of this invention relate generally to wireless communication systems, methods, devices and computer program products and, more specifically, relate to techniques for signaling between a base station and a user device or equipment.

### BACKGROUND

Various abbreviations that appear in the specification and/or in the drawing figures are defined as follows:

3GPP third generation partnership project

aGW access gateway

ASIC application specific integrated circuit

BS base station

BW bandwidth

CQI channel quality indicator

CRC cyclic redundancy check

DL downlink (Node B to UE)

eNB E-UTRAN Node B (evolved Node B)

E-UTRAN evolved UTRAN

FDD frequency division duplex

FDMA frequency division multiple access

FEC forward error correction

HO handover

LTE long term evolution of UTRAN (E-UTRAN)

MBMS multimedia broadcast/multicast service

MIMO multiple input/multiple output

Node B base station

OFDMA orthogonal frequency division multiple access

PDCCH physical downlink control channel

PDSCH physical downlink shared channel

PDSCCH physical downlink shared control channel

PMP point to multi-point

PRB physical resource block

RB resource block

SC-FDMA single carrier-frequency division multiple access

SINR signal to interference plus noise ratio

UE user equipment, such as a mobile station or mobile terminal

UL uplink (UE to Node B)

UTRAN universal terrestrial radio access network

A proposed communication system known as evolved UTRAN (E-UTRAN, also referred to as UTRAN-LTE or as E-UTRA) is currently under discussion within the 3GPP. The current working assumption is that the DL access technique will be OFDMA, and the UL access technique will be SC-FDMA.

One specification of interest to the invention is 3GPP TS 36.300, V8.0.0 (2007-03), 3rd Generation Partnership Project; Technical Specification Group Radio Access Network; Evolved Universal Terrestrial Radio Access (E-UTRA) and Evolved Universal Terrestrial Access Network (E-UTRAN); Overall description; Stage 2 (Release 8).

In a PMP radio system such as 3GPP E-UTRAN, the BS (also referred to as an eNode-B or eNB) signals time-frequency resources allocated to a user terminal or device (also referred as a UE). In the E-UTRAN DL, the resources are allocated in terms of RBs. The number of RBs available in a particular time slot may depend on the BW. As a non-limiting example, the number of RBs may vary from 6 to 100, corresponding to bandwidths of 1.25 MHz to 20 MHz, respectively. Note that other numbers of RBs and other bandwidths (e.g., bandwidths lower than 1.25 MHz or greater than 20 MHz) may be utilized. As a further non-limiting example, the number of RBs may be determined based on a number of subcarriers per RB.

In E-UTRAN it has been decided to use frequency-selective scheduling in the DL in order to allocate the best or most optimum RBs for each UE. This is expected to yield the best performance, but it also incurs a significant amount of signaling overhead (i.e., it is a very expensive way of signaling).

In order for the eNB to know which RBs have the best channel quality, each UE is assumed to report the CQI. One exemplary technique for accomplishing this is by the best-M approach, where the M best RBs are listed together with an average of the SINR. There currently exist several variants of CQI reporting schemes, and furthermore the resolution of the measurement can vary in a practical system. For the purposes of simplifying the explanation, one may assume that the eNB receives a vector of indexes pointing to the best RBs according to measurements made in the UE.

It is assumed that the value of M is BW dependent, and possibly configurable, but in general is significantly less than the total number of RBs.

The complete signaling of an allocation of arbitrary RBs to a UE can be shown to require a bitmap with as many bits as there are RBs. As can be expected, this can result in an expensive signaling technique.

One might consider that a solution to this problem is to use consecutive RB allocations, which can be defined with a starting position and a count of consecutive RBs. In general, this solution needs [log₂(n*(n+1)/2)] bits, where n is the number of RBs. While this approach may require less signaling (i.e., fewer bits), and would work relatively well for wideband allocations, its use would be less than optimal for narrow BW frequency selective scheduling.

Reference with regard to general background information may be made to the following documents: Y. Sun, et. al., “Multi-user Scheduling for OFDMA Downlink with Limited Feedback for Evolved UTRA”, IEEE Proc. VTC-06-fall, September 2006; S. Yoon, C. Suh, Y. Cho, D. Park, “Orthogonal Frequency Division Multiple Access with an Aggregated Sub-Channel Structure and Statistical Channel Quality Measurements”, IEEE Proc. VTC-2004, September 2004; and R1-071346, “CQI Feedback Schemes for E-UTRA”, Motorola, 3GPP TSG RAN1#48-bis, St. Julian's, Malta, Mar. 26-30, 2007.

### SUMMARY

The below summary section is intended to be merely exemplary and non-limiting.

In one exemplary embodiment of the invention, a method comprising: allocating a plurality of resource blocks to obtain a resource allocation; and signaling the resource allocation using an n-bit number, where the n-bit number expresses a value from an overall range of values comprised of a first range of values and a second range of values, where a value within the first range of values specifies a first type of resource allocation and where a value within the second range of values specifies a second type of resource allocation, where the first type of resource allocation is different from the second type of resource allocation.

In another exemplary embodiment of the invention, a program storage device readable by a machine, tangibly embodying a program of instructions executable by the machine for performing operations, said operations comprising: allocating a plurality of resource blocks to obtain a resource allocation; and signaling the resource allocation using an n-bit number, where the n-bit number expresses a value from an overall range of values comprised of a first range of values and a second range of values, where a value within the first range of values specifies a first type of resource allocation and where a value within the second range of values specifies a second type of resource allocation, where the first type of resource allocation is different from the second type of resource allocation.

In another exemplary embodiment of the invention, an apparatus comprising: a processor configured to allocate a plurality of resource blocks to obtain a resource allocation; and a transmitter configured to signal the resource allocation using an n-bit number, where the n-bit number expresses a value from an overall range of values comprised of a first range of values and a second range of values, where a value within the first range of values specifies a first type of resource allocation and where a value within the second range of values specifies a second type of resource allocation, where the first type of resource allocation is different from the second type of resource allocation.

In another exemplary embodiment of the invention, an apparatus comprising: means for allocating a plurality of resource blocks to obtain a resource allocation; and means for signaling the resource allocation using an n-bit number, where the n-bit number expresses a value from an overall range of values comprised of a first range of values and a second range of values, where a value within the first range of values specifies a first type of resource allocation and where a value within the second range of values specifies a second type of resource allocation, where the first type of resource allocation is different from the second type of resource allocation.

In one exemplary embodiment of the invention, a method comprising: receiving an n-bit number; interpreting the n-bit number to determine at least a resource allocation for a plurality of resource blocks, where the n-bit number expresses a value from an overall range of values comprised of a first range of values and a second range of values, where a value within the first range of values specifies a first type of resource allocation and where a value within the second range of values specifies a second type of resource allocation, where the first type of resource allocation is different from the second type of resource allocation; and performing at least one of transmitting or receiving based on the determined resource allocation.

In another exemplary embodiment of the invention, a program storage device readable by a machine, tangibly embodying a program of instructions executable by the machine for performing operations, said operations comprising: receiving an n-bit number; interpreting the n-bit number to determine at least a resource allocation for a plurality of resource blocks, where the n-bit number expresses a value from an overall range of values comprised of a first range of values and a second range of values, where a value within the first range of values specifies a first type of resource allocation and where a value within the second range of values specifies a second type of resource allocation, where the first type of resource allocation is different from the second type of resource allocation; and performing at least one of transmitting or receiving based on the determined resource allocation.

In another exemplary embodiment of the invention, an apparatus comprising: a receiver configured to receive an n-bit number; a processor configured to interpret the n-bit number to determine at least a resource allocation for a plurality of resource blocks, where the n-bit number expresses a value from an overall range of values comprised of a first range of values and a second range of values, where a value within the first range of values specifies a first type of resource allocation and where a value within the second range of values specifies a second type of resource allocation, where the first type of resource allocation is different from the second type of resource allocation; and a transceiver configured to perform at least one of transmitting or receiving based on the determined resource allocation.

In another exemplary embodiment of the invention, an apparatus comprising: means for receiving an n-bit number; means for interpreting the n-bit number to determine at least a resource allocation for a plurality of resource blocks, where the n-bit number expresses a value from an overall range of values comprised of a first range of values and a second range of values, where a value within the first range of values specifies a first type of resource allocation and where a value within the second range of values specifies a second type of resource allocation, where the first type of resource allocation is different from the second type of resource allocation; and means for performing at least one of transmitting or receiving based on the determined resource allocation.

### BRIEF DESCRIPTION OF THE DRAWINGS:

The foregoing and other aspects of exemplary embodiments of this invention are made more evident in the following Detailed Description, when read in conjunction with the attached Drawing Figures, wherein:

FIG. 1 shows a simplified block diagram of various non-limiting, exemplary electronic devices that are suitable for use in practicing the exemplary embodiments of this invention;

FIG. 2 is a table showing a basic signaling example for a 10 MHz band width with 50 RBs, in accordance with exemplary embodiments of this invention;

FIG. 3 is a table showing a more advanced signaling example using a total 12 bits for a 10 MHz bandwidth, further in accordance with exemplary embodiments of this invention;

FIG. 4 is a logic flow diagram that is descriptive of one non-limiting example of a method, and/or operation of computer program products, in accordance with the exemplary embodiments of this invention;

FIG. 5 is a second logic flow diagram that is descriptive of another non-limiting example of a method, and/or operation of computer program products, in accordance with the exemplary embodiments of this invention; and

FIG. 6 is a third logic flow diagram that is descriptive of another non-limiting example of a method, and/or operation of computer program products, in accordance with the exemplary embodiments of this invention.

### DETAILED DESCRIPTION

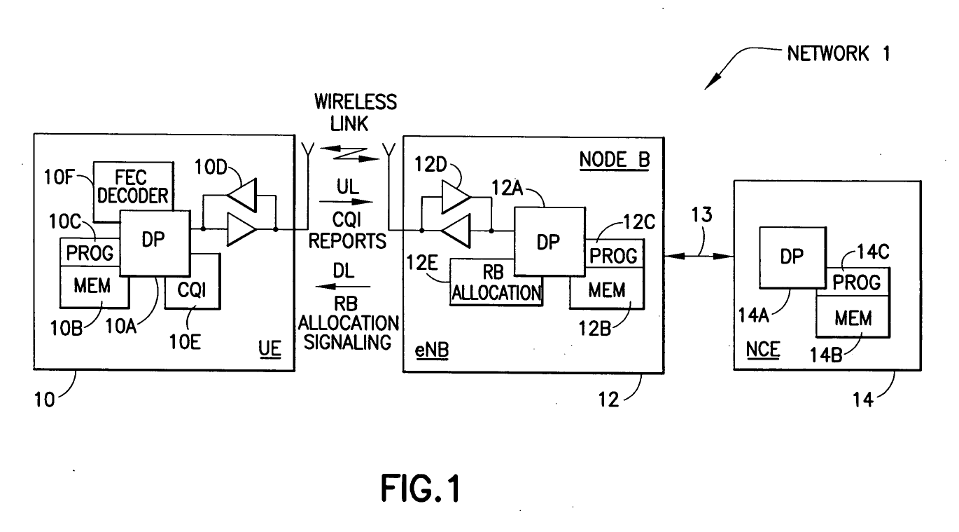

Reference is made first to FIG. 1 for illustrating a simplified block diagram of various non-limiting, exemplary electronic devices that are suitable for use in practicing the exemplary embodiments of this invention. In FIG. 1, a wireless network 1 is adapted for communication with a UE 10 via an eNB (base station) 12. The network 1 may include a network control element (NCE) 14, such as an aGW. The UE 10 includes a data processor (DP) 10A, a memory (MEM) 10B that stores a program (PROG) 10C, and a suitable radio frequency (RF) transceiver 10D for bidirectional wireless communications with the eNB 12. The eNB 12 includes a DP 12A, a MEM 12B that stores a PROG 12C, and a suitable RF transceiver 12D. The eNB 12 is coupled via a data path 13 to a network control element (NCE) 14 that also includes a DP 14A and a MEM 14B storing an associated PROG 14C. At least one of the PROGs 10C, 12C is assumed to include program instructions that, when executed by the associated DP, enable the respective electronic device(s) to operate in accordance with the exemplary embodiments of this invention, as will be discussed below in greater detail.

For the purposes of describing the exemplary embodiments of this invention, the UE 10 is assumed to include a CQI measurement and reporting function (CQI) 10E, and may optionally include a FEC decoder 10F. The eNB 12 is assumed to include a RB allocation function capable of signaling RB allocations in accordance with the exemplary embodiments described below, and the UE 10 is assumed to include functionality to receive the RB allocation signaling and convert (decode, interpret) it into a corresponding RB allocation (and possibly into other information as well, such as signaling modes for example, as described below).

That is, the exemplary embodiments of this invention may be implemented at least in part by computer software executable by the DP 10A of the UE 10 and by the DP 12A of the eNB 12, or by hardware, or by a combination of software and hardware. As shown in FIG. 1, the respective computer software may be stored (embodied, tangibly embodied) on at least one of the respective MEMs 10B, 12B.

In general, the various exemplary embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The MEMs 10B, 12B and 14B may be of any type suitable to the local technical environment and may be implemented using any suitable data storage technology, such as semiconductor-based memory devices, flash memory, magnetic memory devices and systems, optical memory devices and systems, fixed memory and removable memory, as non-limiting examples. The DPs 10A, 12A and 14A may be of any type suitable to the local technical environment, and may include one or more of general purpose computers, special purpose computers, microprocessors, digital signal processors (DSPs) and processors based on a multi-core processor architecture, as non-limiting examples.

In further exemplary embodiments, one or more of the devices 10, 12, 14 depicted in the network 1 of FIG. 1 may comprise one or more of: a plurality of transmitters, a plurality of receivers, a plurality of antennas, a plurality of processors, a plurality of memories and/or a plurality of programs (e.g., two or more programs that collectively operate to implement the exemplary embodiments of the invention). As non-limiting examples, the UE 10 and/or the Node B 12 may be operable to communicate with one or more other devices (e.g., each other) using a MIMO communication technique or a MBMS communication technique.

Initially, it is noted that, as utilized herein, a “range of values” is defined as a plurality of values that are organized, grouped or arranged together, for example, for signaling purposes. The range of values may comprise values that are consecutive to one another, non-consecutive or a combination of the two (e.g., some values are consecutive while other values are not). As another non-limiting example, the range of values may comprise a plurality of values that share a common attribute or characteristic (e.g., all of the values in the range are odd or even, all of the values in the range share a common multiple).

In further exemplary embodiments, and with reference to a plurality of such ranges of values, the values of the ranges may be non-overlapping or partially overlapping, as non-limiting examples. In other exemplary embodiments, the values of each range may be unique, for example, among the values for that range or among all of the possible values. In some exemplary embodiments, the ranges may be separated by one or more “dead values” that are not used (e.g., values that are not included in at least one of the ranges). In other exemplary embodiments, the different ranges directly abut one another such that every possible value is included in at least one of the ranges (no dead values).

For clarity purposes, and by way of example and not limitation, the term “range of values” will be used below in reference to various non-limiting, exemplary embodiments such that each range comprises a plurality of non-overlapping, consecutive values. Furthermore, each range directly abuts (i.e., lies adjacent to) at least one other range and each possible value is a member of only one range. Each exemplary range below comprises a contiguous block of values that are unique not only among the values of the range, but also among all of the possible values, and every possible value is represented (no dead values). Thus, each exemplary range is separate from each other range (non-overlapping) and there is no confusion as to what each value refers (each value is unique). Similarly, with each range comprising a contiguous block of values, the individual ranges can be referred to by the first and last values available for that range such that each range is uniquely defined (since the values of each range are unique). As a non-limiting example, an 11-bit number may comprise three ranges of values that include a first range of values comprised of values 0-1274, a second range of values comprised of values 1275-1786 and a third range of values comprised of values 1787-2047.

It is noted that while the exemplary embodiments of the invention are discussed herein primarily with respect to at least one CQI report (e.g., received by the eNB 12 from the UE 10), the exemplary embodiments of the invention are not limited to use therewith and may be utilized in conjunction with any suitable channel quality information, for example, such as channel quality information that enables usage of a best-M allocation.

The exemplary embodiments of this invention provide a multi-stage approach to RB (i.e., RB allocation) signaling, where one number can signal either a consecutive allocation or a frequency selective allocation that is based on the received best-M channel quality information. The following non-limiting examples illustrate various aspects of the exemplary embodiments using an exemplary system that has a 10 MHz channel with 50 RBs signaled using 11 or 12 bits. However, use of the exemplary embodiments of the invention is not limited to only this particular number of RBs, or this BW, or the specified number of bits.

In order to signal a consecutive RB allocation within the exemplary system, there are 51*50/2=1275 possibilities and, thus, 11 bits are suitable for this purpose. This leaves 2048−1275=773 unused values corresponding to 9 bits, which may be used for an alternative signaling method. The alternative signaling method can be used for selecting the bits from the best-M vector received from the UE 10.

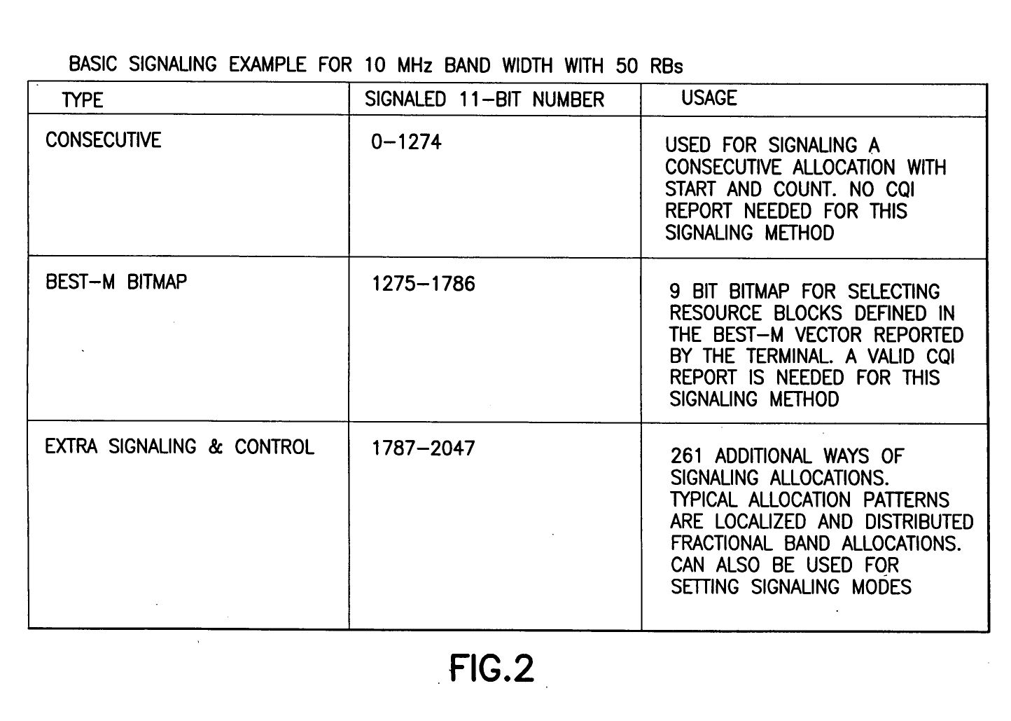

The table shown in FIG. 2 illustrates an exemplary signaling scheme for the 10 MHz example. As shown in FIG. 2, a value from 0-1274 for the 11-bit number corresponds to a consecutive allocation having a starting resource block and a count of resource blocks consecutive to the starting resource block. No CQI report is needed for the consecutive allocation. A value from 1275-1786 corresponds to a best-M bitmap (9 bits) for selecting resource blocks defined in the best-M vector reported by the UE 10. A valid CQI report is needed for this signaling. A value from 1787-2047 is indicative of additional information, such as extra signaling or control-related information. The third range of values provides 261 additional ways of signaling allocations. Such allocations may comprise localized and/or distributed fractional band allocations, as non-limiting examples. The third range may also be used for setting signaling modes, as a non-limiting example.

In practice, it may be beneficial to include error and/or synchronization control in order to ensure reliable reception, and to ensure that the eNB 12 and the UE 10 refer to the same CQI.

In such a case, one may assume that the CQI report is transmitted from the UE 10 with a CRC (or some other error detection and correction information) that ensures the desired reception reliability at the eNB 12. In addition to CRC protection, likelihood values from the FEC decoder 10F of the UE 10 may also be used by the eNB 12. For example, consider an exemplary FEC decoder that operates by comparing the likelihood values of candidate output codewords and selects the codeword with the highest likelihood value. If this highest likelihood value is low in comparison to a certain quality threshold, then the value can be declared unreliable by the FEC decoder and discarded.

Synchronization between the UE 10 and the eNB 12 may be enforced by associating a small number or tag (e.g., two bits) with each received CQI report. This number may be derived from the system frame number, which is known to both the eNB 12 and the UE 10, and thus additional signaling would not be required in the CQI report. When the eNB 12 signals the best-M allocation bitmap, it may include this number or tag with the signaling so that the UE 10 can identify the particular CQI report that was used to derive the best-M bitmap.

If the eNB 12 has correctly and recently received a CQI report (e.g., elapsed time from reception is smaller than the channel coherence time), the eNB 12 may refer to it by the tag when sending the best-M allocation bitmap. If the eNB 12 incorrectly receives a CQI report, but has recently correctly received a previous CQI report, it may refer to the correctly-received CQI report using the 2-bit tag. If the eNB 12 has no valid CQI reports from the UE 10 to use, it may instead use the consecutive allocation alternative when signaling the PRBs. Note that in some exemplary embodiments, the consecutive allocation alternative may always be used at the discretion of the eNB 12.

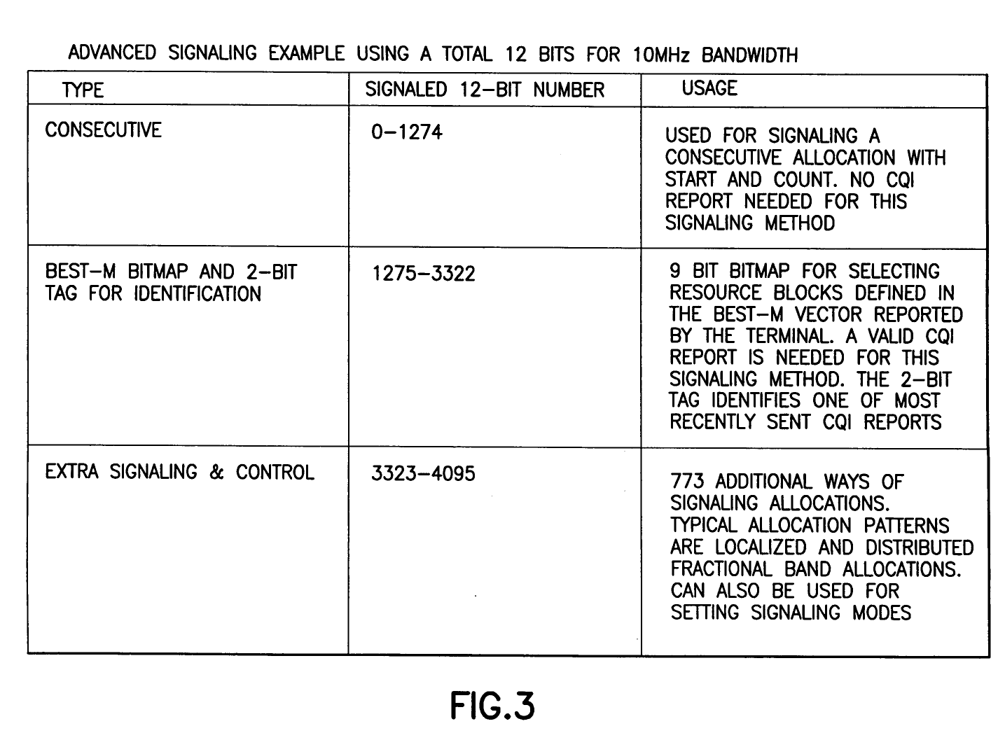

The table depicted in FIG. 3 shows a non-limiting example of a more advanced signaling scheme for the 10 MHz example. This signaling scheme uses a 12-bit number to signal the RB allocation and/or additional information. As shown in FIG. 3, a value from 0-1274 for the 12-bit number corresponds to a consecutive allocation having a starting resource block and a count of resource blocks consecutive to the starting resource block. No CQI report is needed for the consecutive allocation. A value from 1275-3322 corresponds to a best-M bitmap (9 bits) and a 2-bit identification tag. The best-M bitmap is used for selecting resource blocks defined in the best-M vector reported by the UE 10. The 2-bit tag identifies one of the CQI reports (e.g., one of the most recently sent CQI reports) in order to ensure synchronization between the UE and the eNB. As is apparent, a valid CQI report is needed for this signaling. A value from 3323-4095 is indicative of additional information, such as extra signaling or control-related information. The third range of values provides 773 additional ways of signaling allocations. Such allocations may comprise localized and/or distributed fractional band allocations, as non-limiting examples. The third range may also be used for setting signaling modes, as a non-limiting example.

Note that the additional signaling made possible by the range of values shown in the last row in the tables of both FIGS. 2 and 3 (the third range of values), in addition to possibly providing allocation patterns that are localized or distributed fractional band allocations, and/or enabling setting or the specifying of various signaling modes, may also be used for setting UEs into semi-static states for various different purposes.

A localized allocation pattern is considered to be an allocation where the RBs form groups or clusters of consecutive RBs. A distributed allocation is considered to be an allocation where the RBs are spread over the bandwidth (e.g., over the whole bandwidth), for example, without forming any clusters.

The values from the first part (the first range of values) of the exemplary tables in FIGS. 2 and 3 (in the examples, from 0 to 1274) may use an arithmetic algorithm for defining the RBs. The values from the second part (the second range of values) of the exemplary tables (in the FIG. 3 example, from 1275 to 3322) may use the best-M bitmap to select individual RBs from the best-M CQI report signaled by the UE. The values from the third part (the third range of values) of the tables (in the FIG. 3 example, from 3323 to 4095) may operate in a lookup manner to define a predefined allocation pattern for each table entry. Note that the third part of the tables is generally optional and, in other exemplary embodiments, may not be included (e.g., those values are not used).

As can be appreciated, the exemplary embodiments of this invention may be readily implemented by the use of simple arithmetic, logical and look-up table operations in both the eNB 12 and the UE 10, as non-limiting examples. Such techniques, as well as other suitable techniques, are generally known to one of ordinary skill in the art, and such an individual would appreciate the various options available for implementing the exemplary embodiments of the invention as described herein.

The exemplary embodiments of the invention, and particularly those relating to operations performed by the eNB, may further comprise an initial operation of allocating a plurality of RBs to obtain a resource allocation. The obtained resource allocation may subsequently be signaled using an n-bit number, as described in further detail herein. One of ordinary skill in the art would appreciate the various techniques available for allocating the RBs. The exemplary embodiments of the invention may be utilized in conjunction with any such suitable allocation technique.

Furthermore, one of ordinary skill in the art would appreciate the various options and operations available for implementing the signaling of the allocation from the eNB to the UE (e.g., via one or more messages, such as a message transmitted via a PDCCH, PDSCCH or PDSCH). The exemplary embodiments of the invention may be utilized in conjunction with any such suitable transmission technique.

As can be further appreciated, the exemplary embodiments of this invention provide a very efficient and compact technique for signaling downlink resources in EUTRAN by the use of only, for example, 11 or 12 bits, while still providing high capacity scheduling. The use of these exemplary embodiments beneficially provides an allocation signaling procedure that utilizes the CQI information reported by the UE 10.

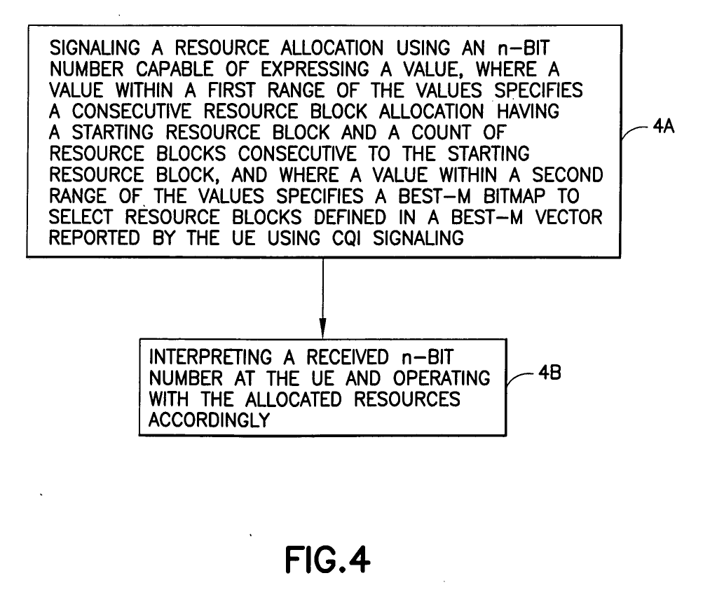

Based on the foregoing it should be apparent that the exemplary embodiments of this invention provide a method, apparatus and computer program product(s) to signal resources from a base station to a UE. In accordance with a method, and referring to FIG. 4, at Block 4A a resource allocation is signaled using an n-bit number capable of expressing a value, where a value within a first range of the values specifies a consecutive resource block allocation having a starting resource block and a count of resource blocks consecutive to the starting resource block, and where a value within a second range of the values specifies a best-M bitmap to select resource blocks defined in a best-M vector reported by the UE using CQI signaling, and further comprising (Block 4B) interpreting a received n-bit number at the UE and operating with the allocated resources accordingly.

The method, apparatus and computer program product(s) in accordance with the preceding paragraph, where a value within a third range of values specifies at least one other type of resource block allocation scheme.

The method, apparatus and computer program product(s) in accordance with the preceding paragraph, where the other type of allocation scheme comprises at least one of localized and distributed fractional band allocations.

The method, apparatus and computer program product(s) in accordance with the preceding paragraph, where a value within the third range of values may specify a signaling mode.

The method, apparatus and computer program product(s) in accordance with the preceding paragraphs, where values within the second range of values further specify a tag used to identify a particular CQI report received from the UE for enabling synchronization between the UE and the base station.

The method, apparatus and computer program product(s) in accordance with the preceding paragraphs, where n is equal to 11 and where the first range of values is from 0-1274, the second range of values is from 1275-1786, and the third range of values is from 1787-2047, or where n is equal to 12 and where the first range of values is from 0-1274, the second range of values is from 1275-3322, and the third range of values is from 3323-4095.

Below are provided further descriptions of various non-limiting, exemplary embodiments. The below-described exemplary embodiments are separately numbered for clarity and identification. This numbering should not be construed as wholly separating the below descriptions since various aspects of one or more exemplary embodiments may be practiced in conjunction with one or more other aspects or exemplary embodiments. As a non-limiting example, where suitable, applicable or practicable, the various aspects, features and/or elements of the exemplary embodiments of the invention as described in the exemplary embodiments below may be claimed in conjunction with one another, for example, in one or more singly-dependent claims or one or more multiply-dependent claims.

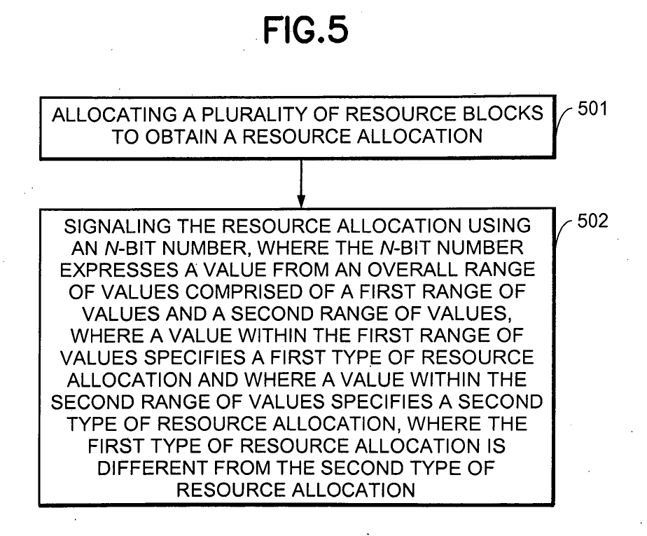

(1) As illustrated in FIG. 5, a method comprising: allocating a plurality of resource blocks to obtain a resource allocation (501); and signaling the resource allocation using an n-bit number, where the n-bit number expresses a value from an overall range of values comprised of a first range of values and a second range of values, where a value within the first range of values specifies a first type of resource allocation and where a value within the second range of values specifies a second type of resource allocation, where the first type of resource allocation is different from the second type of resource allocation (502).

A method as above, where the first type of resource allocation comprises a consecutive resource block allocation having a starting resource block and a count of resource blocks consecutive to the starting resource block, and where the second type of resource allocation comprises a best-M allocation that is based on best-M channel quality information. A method as in any above, where n=11 or n=12. A method as in any above, where a value within the second range of values further specifies a tag operable to identify particular channel quality information. A method as in any above, where the first range of values does not overlap the second range of values (e.g., the first and second ranges are mutually exclusive). A method as in any above, where the overall range of values further comprises a third range of values, where a value within the third range of values specifies at least one other type of resource block allocation scheme. A method as in any above, where the method is executed by a base station. A method as in any above, where the overall range of values further comprises a third range of values, where a value within the third range of values specifies at least one other type of resource block allocation, where the other type of resource block allocation is different from both the first type of resource allocation and the second type of resource allocation.

A method as in any above, where each RB comprises an individual time-frequency resource allocation (e.g., an individual time-frequency resource allocation unit). A method as in any above, where a number of RBs available in a particular time slot depends on a BW. A method as in any above, where a number of the plurality of RBs varies from 6 to 100, corresponding to BWs of 1.25 MHz to 20 MHz. A method as in any above, where a number of the plurality of RBs is determined based on a number of subcarriers per RB.

A method as in any above, where each value of the overall range of values comprises a member of only one of the first range of values or the second range of values. A method as in any above, where at least one of the first range of values or the second range of values comprises a plurality of consecutive values. A method as in any above, where the first range of values and/or the second range of values comprises a plurality of consecutive values. A method as in any above, where at least one of the first range of values or the second range of values consists of a plurality of consecutive values. A method as in any above, where the first range of values and/or the second range of values consists of a plurality of consecutive values. A method as in any above, where at least one value of the overall range of values does not comprise a member of any other constituent range of values. A method as in any above, where the overall range of values consists of the first range of values and the second range of values.

A method as in any above, where the resource allocation further comprises at least one of error control and/or synchronization control. A method as in any above, where the synchronization control ensures that a same channel quality information is identified. A method as in any above, where the resource allocation further comprises at least one CRC. A method as in any above, where the channel quality information comprises a CQI report. A method as in any above, where the method is executed by a base station and the n-bit number is signaled towards a mobile station. A method as in any above, where the synchronization control ensures that a same channel quality information is identified by both the base station and the mobile station. A method as in any above, where values within the second range of values further specify a tag used to identify particular channel quality information (e.g., a particular CQI report) received from a mobile station (or the mobile station) for enabling synchronization between the mobile station and the base station.

A method as in any above, where the overall range of values further comprises a third range of values. A method as in any above, where each value of the overall range of values comprises a member of only one of the first range of values, the second range of values or the third range of values. A method as in any above, where the first range of values does not overlap with the second range of values or the third range of values, and where the second range of values does not overlap with the third range of values. A method as in any above, where at least one of the first range of values, the second range of values and/or the third range of values comprises a plurality of consecutive values. A method as in any above, where at least one of the first range of values, the second range of values and/or the third range of values consists of a plurality of consecutive values.

A method as in any above, where the first range of values comprises values 0-1274. A method as in any above, where the second range of values comprises values 1275-1786. A method as in any above, where the third range of values comprises values 1787-2047. A method as in any above, where the second range of values comprises values 1275-3322. A method as in any above, where the third range of values comprises values 3323-4095. A method as in any above, where the first range of values consists of values 0-1274. A method as in any above, where the second range of values consists of values 1275-1786. A method as in any above, where the third range of values consists of values 1787-2047. A method as in any above, where the second range of values consists of values 1275-3322. A method as in any above, where the third range of values consists of values 3323-4095.

A method as in any above, where the first range of values comprises values 0-1274, the second range of values comprises values 1275-1786 and the third range of values comprises values 1787-2047. A method as in any above, where the first range of values comprises values 0-1274, the second range of values comprises values 1275-1786 and the third range of values comprises values 1787-2047. A method as in any above, where the first range of values consists of values 0-1274, the second range of values consists of values 1275-3322 and the third range of values consists of values 3323-4095. A method as in any above, where the first range of values consists of values 0-1274, the second range of values consists of values 1275-3322 and the third range of values consists of values 3323-4095.

A method as in any above, where n=11, and where the first range of values comprises values 0-1274, the second range of values comprises values 1275-1786 and the third range of values comprises values 1787-2047. A method as in any above, where n=11, and where the first range of values comprises values 0-1274, the second range of values comprises values 1275-1786 and the third range of values comprises values 1787-2047. A method as in any above, where n=12, and where the first range of values consists of values 0-1274, the second range of values consists of values 1275-3322 and the third range of values consists of values 3323-4095. A method as in any above, where n=12, and where the first range of values consists of values 0-1274, the second range of values consists of values 1275-3322 and the third range of values consists of values 3323-4095.

A method as in any above, where n is equal to 11 and where the first range of values is from 0-1274, the second range of values is from 1275-1786, and the third range of values is from 1787-2047. A method as in any above, where n is equal to 12 and where the first range of values is from 0-1274, the second range of values is from 1275-3322, and the third range of values is from 3323-4095. A method as in any above, where n is equal to 11 and where the first range of values is from 0-1274, the second range of values is from 1275-1786, and the third range of values is from 1787-2047, or where n is equal to 12 and where the first range of values is from 0-1274, the second range of values is from 1275-3322, and the third range of values is from 3323-4095.

A method as in any above, where the overall range of values further comprises a third range of values. A method as in any above, where a value within the third range of values specifies at least one other type of resource block allocation scheme. A method as in any above, where a value within the third range of values specifies at least one other type of resource block allocation scheme, and where the other type of allocation scheme comprises at least one of a localized allocation (e.g., an allocation where the RBs form groups or clusters of consecutive RBs) and/or a distributed fractional band allocation (e.g., where the RBs are spread over the bandwidth (e.g., over the whole bandwidth), for example, without forming any clusters). A method as in any above, where a value within the third range of values specifies a signaling mode. A method as in any above, where a value within the third range of values is used to set at least one mobile station into a semi-static state.

A method as in any above, where the consecutive allocation is for a wideband allocation. A method as in any above, where the best-M allocation bitmap is for a narrowband allocation. A method as in any above, where the first range of values use an arithmetic algorithm for defining the RBs. A method as in any above, where the channel quality information comprises a best-M CQI report signaled by a mobile station, and where the second range of values use the best-M allocation bitmap to select individual RBs from the received best-M CQI report. A method as in any above, where the third range of values operate in a lookup manner to define a predefined allocation pattern.

A method as in any above, where the channel quality information comprises at least one CQI report, where the method is performed by a base station, the method further comprising: receiving a CQI report. A method as in any above, where the channel quality information comprises at least one CQI report, where the method is performed by a base station, the method further comprising: receiving a CQI report from at least one mobile station. A method as in any above, where the channel quality information comprises at least one CQI report, where the method is performed by a base station, the method further comprising: receiving a CQI report from each mobile station in communication with the base station. A method as in any above, where the channel quality information comprises at least one CQI report, where the method is performed by a base station, the method further comprising: receiving a CQI report from at least one mobile station in communication with the base station. A method as in any above, where the channel quality information comprises at least one CQI report, where the method is performed by a base station, the method further comprising: receiving a vector of indexes pointing to best RBs according to measurements made in at least one mobile station. A method as in any above, where the channel quality information comprises at least one CQI report, where the method is performed by a base station, the method further comprising: receiving a CQI report comprised of M best RBs listed together with an average of SINR. A method as in any above, where M is significantly (e.g., substantially) less than a total number of RBs.

A method as in any above, where the channel quality information comprises at least one CQI report, where a (small) number or tag is associated with each received CQI report. A method as in any above, where the channel quality information comprises at least one CQI report, the method further comprising associating a (small) number or tag with each received CQI report. A method as in any above, where the channel quality information comprises at least one CQI report, the method further comprising receiving at least one CQI report; and associating a (small) number or tag with each received CQI report. A method as in any above, where the tag comprises a 2-bit number. A method as in any above, where the tag is derived from a system frame number. A method as in any above, where the tag is operable to enable identification of a particular CQI report. A method as in any above, where the tag is operable to enable identification of a particular CQI report (that was) used to derive a (the) best-M bitmap.

A method as in any above, where for the case that (in response to) the base station has correctly and recently received a CQI report (e.g., elapsed time from reception is smaller than a channel coherence time), the base station refers to the received CQI report by the corresponding tag when signaling the best-M allocation bitmap. A method as in any above, where for the case that (in response to) the base station has incorrectly received a CQI report and the base station has recently correctly received a previous CQI report, the base station refers to the (correctly-received) previous CQI report by the corresponding tag when signaling the best-M allocation bitmap. A method as in any above, where for the case that (in response to) the base station does not have a valid CQI report from the mobile station, the base station uses a consecutive allocation for the resource allocation. A method as in any above, where a consecutive allocation is signaled at the discretion of a base station. A method as in any above, where the method is performed by a base station, and where a consecutive allocation is signaled at a (the) discretion of the base station. A method as in any above, where the method is performed by a base station, an evolved Node B, a relay station, an access node, an access point or a network communication element. A method as in any above, where the method is implemented within a wireless communication system. A method as in any above, where the method is implemented within an evolved universal terrestrial radio access network.

A method as in any above, where the method is implemented by a computer program. A method as in any above, where the method is implemented by a computer program tangibly embodied (e.g., stored) on a computer-readable medium. A method as in any above, where the method is implemented by a program of instructions stored on a program storage device readable by a machine, where execution of the program of instructions by the machine results in operations comprising the steps of performing the method. A method as in any above, where the method is implemented by a computer program stored on a computer-readable medium (e.g., a memory), where execution of the computer program results in operations comprising the steps of performing the method. A method as in any above, further comprising one or more additional aspects of the exemplary embodiments of the invention as described in further detail elsewhere herein.

(2) A program storage device readable by a machine, tangibly embodying a program of instructions executable by the machine for performing operations, said operations comprising: allocating a plurality of resource blocks to obtain a resource allocation (501); and signaling the resource allocation using an n-bit number, where the n-bit number expresses a value from an overall range of values comprised of a first range of values and a second range of values, where a value within the first range of values specifies a first type of resource allocation and where a value within the second range of values specifies a second type of resource allocation, where the first type of resource allocation is different from the second type of resource allocation (502).

A program storage device as in any above, where the machine comprises a base station, an evolved Node B, a relay station, an access node, an access point or a network communication element. A program storage device as in any above, where the machine comprises a node of a wireless communication system. A program storage device as in any above, where the machine comprises a node in an evolved universal terrestrial radio access network. A program storage device as in any above, further comprising one or more additional aspects of the exemplary embodiments of the invention as described in further detail elsewhere herein, including those described in (1). A program storage device as in any above, further comprising one or more additional aspects of any (one) exemplary method of the invention as described in further detail elsewhere herein.

(3) An apparatus comprising: a processor configured to allocate a plurality of resource blocks to obtain a resource allocation; and a transmitter configured to signal the resource allocation using an n-bit number, where the n-bit number expresses a value from an overall range of values comprised of a first range of values and a second range of values, where a value within the first range of values specifies a first type of resource allocation and where a value within the second range of values specifies a second type of resource allocation, where the first type of resource allocation is different from the second type of resource allocation.

An apparatus as above, where n=11 or n=12. An apparatus as in any above, where a value within the second range of values further specifies a tag operable to identify particular channel quality information. An apparatus as in any above, where the first range of values does not overlap the second range of values. An apparatus as in any above, where the overall range of values further comprises a third range of values, where a value within the third range of values specifies at least one other type of resource block allocation scheme. An apparatus as in any above, where the apparatus comprises a base station. An apparatus as in any above, where the apparatus comprises an evolved Node B, a relay station, an access node, an access point or a network communication element. An apparatus as in any above, where the apparatus comprises a node of a wireless communication system. An apparatus as in any above, where the apparatus comprises a node in an evolved universal terrestrial radio access network. An apparatus as in any above, where the first type of resource allocation comprises a consecutive resource block allocation having a starting resource block and a count of resource blocks consecutive to the starting resource block, and where the second type of resource allocation comprises a best-M allocation that is based on best-M channel quality information. An apparatus as in any above, where the overall range of values further comprises a third range of values, where a value within the third range of values specifies at least one other type of resource block allocation, where the other type of resource block allocation is different from both the first type of resource allocation and the second type of resource allocation.

An apparatus as in any above, further comprising one or more additional aspects of the exemplary embodiments of the invention as described in further detail elsewhere herein. An apparatus as in any above, where at least one of the processor, the transmitter and/or one or more other/additional components (e.g., at least one other processor, at least one other transmitter, at least one receiver, at least one processing block, at least one component block, at least one type of circuit, at least one block of circuitry, at least one integrated circuit, at least one ASIC, at least one function, at least one program, at least one storage component, at least one memory, at least one subscriber identity module, at least one transceiver, at least one communication component, at least one processing component) is operable (configured) to function, operate and/or perform in accordance with one or more aspects of the exemplary embodiments of the invention as described in further detail herein, such as one or more aspects of the exemplary embodiments of the invention as described above in (1) with respect to various exemplary methods, as a non-limiting example.

(4) An apparatus comprising: means for allocating a plurality of resource blocks to obtain a resource allocation; and means for signaling the resource allocation using an n-bit number, where the n-bit number expresses a value from an overall range of values comprised of a first range of values and a second range of values, where a value within the first range of values specifies a first type of resource allocation and where a value within the second range of values specifies a second type of resource allocation, where the first type of resource allocation is different from the second type of resource allocation.

An apparatus as above, where the means for allocating comprises at least one processor. An apparatus as in any above, where the means for signaling comprises at least one transceiver. An apparatus as in any above, further comprising at least one means for receiving. An apparatus as in the previous, where the means for receiving comprises at least one receiver. An apparatus as in any above, further comprising a means for storing. An apparatus as in the previous, where the means for storing comprises at least one storage device (e.g., a memory, a computer-readable medium).

An apparatus as in any above, where the apparatus comprises a base station, an evolved Node B, a relay station, an access node, an access point or a network communication element. An apparatus as in any above, where the apparatus comprises a node of a wireless communication system. An apparatus as in any above, where the apparatus comprises a node in an evolved universal terrestrial radio access network. An apparatus as in any above, further comprising one or more additional aspects of the exemplary embodiments of the invention as described in further detail elsewhere herein.

An apparatus as in any above, where at least one of the means for allocation, the means for signaling and/or one or more other/additional components (e.g., at least one other means for processing, at least one other means for signaling/transmitting, at least one means for receiving, at least one processing block, at least one component block, at least one type of circuit, at least one block of circuitry, at least one integrated circuit, at least one ASIC, at least one function, at least one program, at least one means for storage, at least one memory, at least one subscriber identity module, at least one transceiver, at least one communication component, at least one processing component) is operable (configured) to function, operate and/or perform in accordance with one or more aspects of the exemplary embodiments of the invention as described in further detail herein, such as one or more aspects of the exemplary embodiments of the invention as described above in (1) with respect to various exemplary methods, as a non-limiting example.

(5) An apparatus comprising: allocation circuitry configured to allocate a plurality of resource blocks to obtain a resource allocation; and transmission circuitry configured to signal the resource allocation using an n-bit number, where the n-bit number expresses a value from an overall range of values comprised of a first range of values and a second range of values, where a value within the first range of values specifies a first type of resource allocation and where a value within the second range of values specifies a second type of resource allocation, where the first type of resource allocation is different from the second type of resource allocation.

An apparatus as in any above, where the apparatus comprises a base station, an evolved Node B, a relay station, an access node, an access point or a network communication element. An apparatus as in any above, where the apparatus comprises a node of a wireless communication system. An apparatus as in any above, where the apparatus comprises a node in an evolved universal terrestrial radio access network. An apparatus as in any above, where the apparatus comprises an integrated circuit. An apparatus as in any above, further comprising one or more additional aspects of the exemplary embodiments of the invention as described in further detail elsewhere herein.

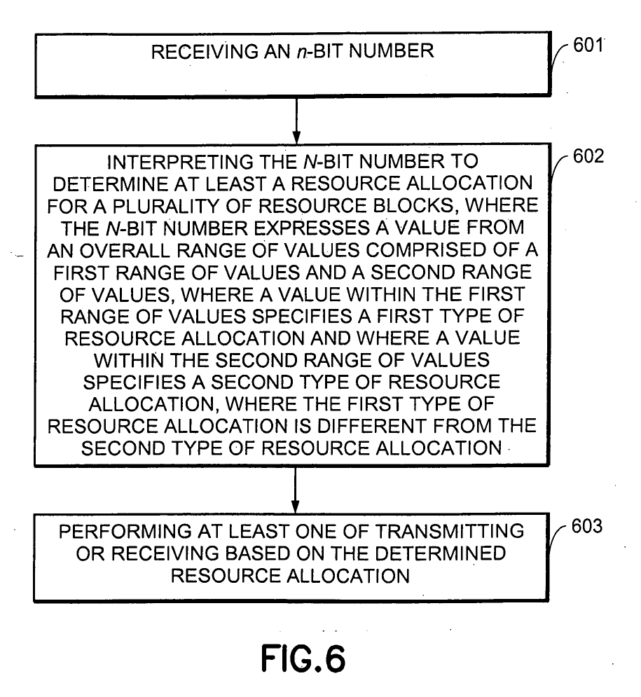

(6) As illustrated in FIG. 6, a method comprising: receiving an n-bit number (601); interpreting the n-bit number to determine at least a resource allocation for a plurality of resource blocks, where the n-bit number expresses a value from an overall range of values comprised of a first range of values and a second range of values, where a value within the first range of values specifies a first type of resource allocation and where a value within the second range of values specifies a second type of resource allocation, where the first type of resource allocation is different from the second type of resource allocation (602); and performing at least one of transmitting or receiving based on the determined resource allocation (603).

A method as above, where n=11 or n=12. A method as in any above, where a value within the second range of values further specifies a tag operable to identify particular channel quality information. A method as in any above, where the first range of values does not overlap the second range of values. A method as in any above, where the overall range of values further comprises a third range of values, where a value within the third range of values specifies at least one other type of resource block allocation scheme. A method as in any above, where the method is executed by a mobile station. An method as in any above, where the method is performed by a mobile device, a mobile node, a mobile phone, a mobile terminal, a cellular phone or a portable electronic device. A method as in any above, where the first type of resource allocation comprises a consecutive resource block allocation having a starting resource block and a count of resource blocks consecutive to the starting resource block, and where the second type of resource allocation comprises a best-M allocation that is based on best-M channel quality information. A method as in any above, where the overall range of values further comprises a third range of values, where a value within the third range of values specifies at least one other type of resource block allocation, where the other type of resource block allocation is different from both the first type of resource allocation and the second type of resource allocation.

A method as in any above, further comprising: determining if a value of the received n-bit number is reliable by utilizing at least one comparison made by a FEC decoder. A method as in any above, where and performing at least one of transmitting or receiving based on the determined resource allocation comprises transmitting a message based on the determined resource allocation. A method as in any above, where and performing at least one of transmitting or receiving based on the determined resource allocation comprises receiving a message based on the determined resource allocation. A method as in any above, where the method is implemented within a wireless communication system. A method as in any above, where the method is implemented within an evolved universal terrestrial radio access network.

A method as in any above, further comprising one or more additional aspects of the exemplary embodiments of the invention as described in further detail elsewhere herein. A method as in any above, further comprising one or more additional aspects of any (one) exemplary method of the invention as described in further detail elsewhere herein. A method as in any above, further comprising one or more additional aspects of the exemplary embodiments of the invention as described above in (1) with respect to suitable or applicable aspects (e.g., suitable for use with a mobile device or applicable to operation of a mobile device) of various exemplary methods, as non-limiting examples.

A method as in any above, where the method is implemented by a computer program. A method as in any above, where the method is implemented by a computer program tangibly embodied (e.g., stored) on a computer-readable medium. A method as in any above, where the method is implemented by a program of instructions stored on a program storage device readable by a machine, where execution of the program of instructions by the machine results in operations comprising the steps of performing the method. A method as in any above, where the method is implemented by a computer program stored on a computer-readable medium (e.g., a memory), where execution of the computer program results in operations comprising the steps of performing the method.

(7) A program storage device readable by a machine, tangibly embodying a program of instructions executable by the machine for performing operations, said operations comprising: receiving an n-bit number (601); interpreting the n-bit number to determine at least a resource allocation for a plurality of resource blocks, where the n-bit number expresses a value from an overall range of values comprised of a first range of values and a second range of values, where a value within the first range of values specifies a first type of resource allocation and where a value within the second range of values specifies a second type of resource allocation, where the first type of resource allocation is different from the second type of resource allocation (602); and performing at least one of transmitting or receiving based on the determined resource allocation (603).

A program storage device as in any above, where the machine comprises a mobile station, a mobile device, a mobile node, a mobile phone, a mobile terminal, a cellular phone or a portable electronic device. A program storage device as in any above, where the machine comprises a node of a wireless communication system. A program storage device as in any above, where the machine comprises a node in an evolved universal terrestrial radio access network. A program storage device as in any above, further comprising one or more additional aspects of the exemplary embodiments of the invention as described in further detail elsewhere herein, including those described in (6) above. A program storage device as in any above, further comprising one or more additional aspects of any (one) exemplary method of the invention as described in further detail elsewhere herein.

(8) An apparatus comprising: a receiver configured to receive an n-bit number; a processor configured to interpret the n-bit number to determine at least a resource allocation for a plurality of resource blocks, where the n-bit number expresses a value from an overall range of values comprised of a first range of values and a second range of values, where a value within the first range of values specifies a first type of resource allocation and where a value within the second range of values specifies a second type of resource allocation, where the first type of resource allocation is different from the second type of resource allocation; and a transceiver configured to perform at least one of transmitting or receiving based on the determined resource allocation.

An apparatus as above, where n=11 or n=12. An apparatus as in any above, where a value within the second range of values further specifies a tag operable to identify particular channel quality information. An apparatus as in any above, where the first range of values does not overlap the second range of values. An apparatus as in any above, where the overall range of values further comprises a third range of values, where a value within the third range of values specifies at least one other type of resource block allocation scheme. An apparatus as in any above, where the apparatus comprises a mobile station. An apparatus as in any above, where the apparatus comprises a mobile device, a mobile node, a mobile phone, a mobile terminal, a cellular phone or a portable electronic device. An apparatus as in any above, where the apparatus comprises a node of a wireless communication system. An apparatus as in any above, where the apparatus comprises a node in an evolved universal terrestrial radio access network. An apparatus as in any above, where the first type of resource allocation comprises a consecutive resource block allocation having a starting resource block and a count of resource blocks consecutive to the starting resource block, and where the second type of resource allocation comprises a best-M allocation that is based on best-M channel quality information. An apparatus as in any above, where the overall range of values further comprises a third range of values, where a value within the third range of values specifies at least one other type of resource block allocation, where the other type of resource block allocation is different from both the first type of resource allocation and the second type of resource allocation.

An apparatus as in any above, further comprising one or more additional aspects of the exemplary embodiments of the invention as described in further detail elsewhere herein. An apparatus as in any above, where at least one of the receiver, the processor, the transceiver and/or one or more other/additional components (e.g., at least one other processor, at least one other transceiver, at least one other receiver, at least one transmitter, at least one processing block, at least one component block, at least one type of circuit, at least one block of circuitry, at least one integrated circuit, at least one ASIC, at least one function, at least one program, at least one storage component, at least one memory, at least one subscriber identity module, at least one transceiver, at least one communication component, at least one processing component) is operable (configured) to function, operate and/or perform in accordance with one or more aspects of the exemplary embodiments of the invention as described in further detail herein, such as one or more aspects of the exemplary embodiments of the invention as described above in (6) with respect to various exemplary methods, or in (1) with respect to suitable or applicable aspects of various exemplary methods, as non-limiting examples.

(9) An apparatus comprising: means for receiving an n-bit number; means for interpreting the n-bit number to determine at least a resource allocation for a plurality of resource blocks, where the n-bit number expresses a value from an overall range of values comprised of a first range of values and a second range of values, where a value within the first range of values specifies a first type of resource allocation and where a value within the second range of values specifies a second type of resource allocation, where the first type of resource allocation is different from the second type of resource allocation; and means for performing at least one of transmitting or receiving based on the determined resource allocation.

An apparatus as above, where the means for receiving comprises at least one receiver. An apparatus as in any above, where the means for interpreting comprises at least one processor. An apparatus as in any above, where the means for performing at least one of transmitting or receiving comprises at least one transmitter and/or at least one receiver. An apparatus as in any above, where the means for performing at least one of transmitting or receiving comprises at least one of a transmitter or a receiver. An apparatus as in any above, further comprising a means for storing. An apparatus as in the previous, where the means for storing comprises at least one storage device (e.g., a memory, a computer-readable medium). An apparatus as in any above, where the apparatus comprises a mobile station, a mobile device, a mobile node, a mobile phone, a mobile terminal, a cellular phone or a portable electronic device. An apparatus as in any above, where the apparatus comprises a node of a wireless communication system. An apparatus as in any above, where the apparatus comprises a node in an evolved universal terrestrial radio access network.

An apparatus as in any above, further comprising one or more additional aspects of the exemplary embodiments of the invention as described in further detail elsewhere herein. An apparatus as in any above, where at least one of the means for receiving, the means for interpreting, the means for performing and/or one or more other/additional components (e.g., at least one means for processing, at least one means for transmitting, at least one other means for receiving, at least one processing block, at least one component block, at least one type of circuit, at least one block of circuitry, at least one integrated circuit, at least one ASIC, at least one function, at least one program, at least one means for storing, at least one memory, at least one subscriber identity module, at least one transceiver, at least one communication component, at least one processing component) is operable (configured) to function, operate and/or perform in accordance with one or more aspects of the exemplary embodiments of the invention as described in further detail herein, such as one or more aspects of the exemplary embodiments of the invention as described above in (6) with respect to various exemplary methods, or in (1) with respect to suitable or applicable aspects of various exemplary methods, as non-limiting examples.

(10) An apparatus comprising: receiver circuitry configured to receive an n-bit number; interpretation circuitry configured to interpret the n-bit number to determine at least a resource allocation for a plurality of resource blocks, where the n-bit number expresses a value from an overall range of values comprised of a first range of values and a second range of values, where a value within the first range of values specifies a first type of resource allocation and where a value within the second range of values specifies a second type of resource allocation, where the first type of resource allocation is different from the second type of resource allocation; and transmission/reception circuitry configured to perform at least one of transmitting or receiving based on the determined resource allocation.

An apparatus as above, where the apparatus comprises an integrated circuit. An apparatus as in any above, where the apparatus comprises a mobile station, a mobile device, a mobile node, a mobile phone, a mobile terminal, a cellular phone or a portable electronic device. An apparatus as in any above, where the apparatus comprises a node of a wireless communication system. An apparatus as in any above, where the apparatus comprises a node in an evolved universal terrestrial radio access network. An apparatus as in any above, where the apparatus comprises an integrated circuit. An apparatus as in any above, further comprising one or more additional aspects of the exemplary embodiments of the invention as described in further detail elsewhere herein.

The exemplary embodiments of the invention, as discussed above and as particularly described with respect to exemplary methods, may be implemented as a computer program product comprising program instructions embodied on a tangible computer-readable medium. Execution of the program instructions results in operations comprising steps of utilizing the exemplary embodiments or steps of the method.

The exemplary embodiments of the invention, as discussed above and as particularly described with respect to exemplary methods, may be implemented in conjunction with a program storage device (e.g., a computer-readable medium, a memory) readable by a machine (e.g., a computer, a mobile station, a mobile device, a mobile node), tangibly embodying a program of instructions (e.g., a program, a computer program) executable by the machine for performing operations. The operations comprise steps of utilizing the exemplary embodiments or steps of the method.

The various blocks shown in one or more of FIGS. 4, 5 and/or 6 may be viewed as method steps, and/or as operations that result from operation of computer program code, and/or as a plurality of coupled logic circuit elements constructed to carry out the associated function(s).

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the inventions may be practiced in various components such as integrated circuit chips (e.g., ASICs) and modules. The design of integrated circuits is by and large a highly automated process. Complex and powerful software tools are available for converting a logic level design into a semiconductor circuit design ready to be fabricated on a semiconductor substrate. Such software tools can automatically route conductors and locate components on a semiconductor substrate using well established rules of design, as well as libraries of pre-stored design modules. Once the design for a semiconductor circuit has been completed, the resultant design, in a standardized electronic format (e.g., Opus, GDSII, or the like) may be transmitted to a semiconductor fabrication facility for fabrication as one or more integrated circuit devices.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

For example, while the exemplary embodiments have been described above in the context of the E-UTRAN (UTRAN-LTE) system, it should be appreciated that the exemplary embodiments of this invention are not limited for use with only this one particular type of wireless communication system, and that they may be used to advantage in other wireless communication systems. As another non-limiting example, while described above with specific reference to a consecutive allocation scheme and a best-M allocation scheme, the exemplary embodiments of the invention may be utilized in conjunction with at least two other types of allocation schemes such that the n-bit number utilizes at least two ranges of values operable to specify at least the two other types of allocation schemes.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

What is claimed is:

1. A method comprising:
allocating a plurality of resource blocks to obtain a resource allocation; and
signaling the resource allocation using an n-bit number, where the n-bit number expresses a value from an overall range of values comprised of a first range of values and a second range of values, where a value within the first range of values specifies a first type of resource allocation and a value within the second range of values specifies a second type of resource allocation, where the first type of resource allocation is different from the second type of resource allocation.

2. A method as in claim 1, where the first type of resource allocation comprises a consecutive resource block allocation having a starting resource block and a count of resource blocks consecutive to the starting resource block, and where the second type of resource allocation comprises a best-M allocation that is based on best-M channel quality information.

3. A method as in claim 1, where n=11 or n=12.

4. A method as in claim 1, where a value within the second range of values further specifies a tag operable to identify particular channel quality information.

5. A method as in claim 1, where the first range of values does not overlap the second range of values.

6. A method as in claim 1, where the overall range of values further comprises a third range of values, where a value within the third range of values specifies at least one other type of resource block allocation, where the other type of resource block allocation is different from both the first type of resource allocation and the second type of resource allocation.

7. A program storage device readable by a machine, tangibly embodying a program of instructions executable by the machine for performing operations, said operations comprising:
allocating a plurality of resource blocks to obtain a resource allocation; and
signaling the resource allocation using an n-bit number, where the n-bit number expresses a value from an overall range of values comprised of a first range of values and a second range of values, where a value within the first range of values specifies a first type of resource allocation and a value within the second range of values specifies a second type of resource allocation, where the first type of resource allocation is different from the second type of resource allocation.

8. A program storage device as in claim 7, where the first type of resource allocation comprises a consecutive resource block allocation having a starting resource block and a count of resource blocks consecutive to the starting resource block, and where the second type of resource allocation comprises a best-M allocation that is based on best-M channel quality information.

9. A program storage device as in claim 7, where the first range of values does not overlap the second range of values.

10. A program storage device as in claim 7, where the overall range of values further comprises a third range of values, where a value within the third range of values specifies at least one other type of resource block allocation, where the other type of resource block allocation is different from both the first type of resource allocation and the second type of resource allocation.

11. An apparatus comprising:
a processor configured to allocate a plurality of resource blocks to obtain a resource allocation; and
a transmitter configured to signal the resource allocation using an n-bit number, where the n-bit number expresses a value from an overall range of values comprised of a first range of values and a second range of values, where a value within the first range of values specifies a first type of resource allocation and a value within the second range of values specifies a second type of resource allocation, where the first type of resource allocation is different from the second type of resource allocation.

12. An apparatus as in claim 11, where the first type of resource allocation comprises a consecutive resource block allocation having a starting resource block and a count of resource blocks consecutive to the starting resource block, and where the second type of resource allocation comprises a best-M allocation that is based on best-M channel quality information.

13. An apparatus as in claim 1, where n=11 or n=12.

14. An apparatus as in claim 11, where a value within the second range of values further specifies a tag operable to identify particular channel quality information.

15. An apparatus as in claim 11, where the first range of values does not overlap the second range of values.

16. An apparatus as in claim 11, where the overall range of values further comprises a third range of values, where a value within the third range of values specifies at least one other type of resource block allocation, where the other type of resource block allocation is different from both the first type of resource allocation and the second type of resource allocation.

17. An apparatus as in claim 11, where the apparatus comprises a base station.

18. A method comprising:
receiving an n-bit number;
interpreting the n-bit number to determine at least a resource allocation for a plurality of resource blocks, where the n-bit number expresses a value from an overall range of values comprised of a first range of values and a second range of values, where a value within the first range of values specifies a first type of resource allocation and a value within the second range of values specifies a second type of resource allocation, where the first type of resource allocation is different from the second type of resource allocation; and
performing at least one of transmitting or receiving based on the determined resource allocation.

19. A method as in claim 18, where the first type of resource allocation comprises a consecutive resource block allocation having a starting resource block and a count of resource blocks consecutive to the starting resource block, and where the second type of resource allocation comprises a best-M allocation that is based on best-M channel quality information.

20. A method as in claim 18, where a value within the second range of values further specifies a tag operable to identify particular channel quality information.

21. A method as in claim 18, where the first range of values does not overlap the second range of values.

22. A method as in claim 18, where the overall range of values further comprises a third range of values, where a value within the third range of values specifies at least one other type of resource block allocation, where the other type of resource block allocation is different from both the first type of resource allocation and the second type of resource allocation.

23. A program storage device readable by a machine, tangibly embodying a program of instructions executable by the machine for performing operations, said operations comprising:
receiving an n-bit number;
interpreting the n-bit number to determine at least a resource allocation for a plurality of resource blocks, where the n-bit number expresses a value from an overall range of values comprised of a first range of values and a second range of values, where a value within the first range of values specifies a first type of resource allocation and a value within the second range of values specifies a second type of resource allocation, where the first type of resource allocation is different from the second type of resource allocation; and
performing at least one of transmitting or receiving based on the determined resource allocation.

24. A program storage device as in claim 23, where the first type of resource allocation comprises a consecutive resource block allocation having a starting resource block and a count of resource blocks consecutive to the starting resource block, and where the second type of resource allocation comprises a best-M allocation that is based on best-M channel quality information.

25. A program storage device as in claim 23, where the first range of values does not overlap the second range of values.

26. A program storage device as in claim 23, where the overall range of values further comprises a third range of values, where a value within the third range of values specifies at least one other type of resource block allocation, where the other type of resource block allocation is different from both the first type of resource allocation and the second type of resource allocation.

27. An apparatus comprising:
a receiver configured to receive an n-bit number;
a processor configured to interpret the n-bit number to determine at least a resource allocation for a plurality of resource blocks, where the n-bit number expresses a value from an overall range of values comprised of a first range of values and a second range of values, where a value within the first range of values specifies a first type of resource allocation and a value within the second range of values specifies a second type of resource allocation, where the first type of resource allocation is different from the second type of resource allocation; and
a transceiver configured to perform at least one of transmitting or receiving based on the determined resource allocation.

28. An apparatus as in claim 27, where the first type of resource allocation comprises a consecutive resource block allocation having a starting resource block and a count of resource blocks consecutive to the starting resource block, and where the second type of resource allocation comprises a best-M allocation that is based on best-M channel quality information.

29. An apparatus as in claim 27, where n=11 or n=12.

30. An apparatus as in claim 27, where a value within the second range of values further specifies a tag operable to identify particular channel quality information.

31. An apparatus as in claim 27, where the first range of values does not overlap the second range of values.

32. An apparatus as in claim 27, where the overall range of values further comprises a third range of values, where a value within the third range of values specifies at least one other type of resource block allocation, where the other type of resource block allocation is different from both the first type of resource allocation and the second type of resource allocation.

33. An apparatus as in claim 27, where the apparatus comprises a mobile station.
